(19) United States
(12) Patent Application Publication
(10) Pub. No.: US 2006/0115584 A1
(43) Pub. Date: Jun. 1, 2006

(54) Production process and production system of magnetic recording medium

(75) Inventors: Kazuhiro Hattori, Tokyo (JP); Mitsuru Takai, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 10/544,895

(22) PCT Filed: Aug. 3, 2004
(86) PCT No.: PCT/JP04/11085

§ 371 Date: Aug. 8, 2005

(30) Foreign Application Priority Data
Aug. 7, 2003 (JP) 2003-289191

(51) Int. Cl. B05D 5/12; G11B 5/84

(52) U.S. Cl. 427/127

(57) ABSTRACT

A manufacturing method and a manufacturing apparatus of a magnetic recording medium are provided, which can efficiently manufacture a magnetic recording medium having good magnetic characteristics while suppressing warpage of the medium, magnetic degradation of divided recording elements, and misalignment of the processed shape of the divided recording elements. In the manufacturing method and the manufacturing apparatus, both surfaces of an object to be processed 10 are simultaneously processed. As a dry etching technique for a continuous recording layer 20, ion beam etching is employed. A resist layer 26 is removed before dry etching of the continuous recording layer 20.

### TECHNICAL FIELD

The present invention relates to a manufacturing method of a magnetic recording medium in which divided recording layers are formed on both surfaces of a substrate and a manufacturing apparatus of such a magnetic recording medium.

### BACKGROUND ART

Conventionally, in a magnetic recording medium such as a hard disc, various improvements such as miniaturization of magnetic particles forming a recording layer, material change for the magnetic particles, and increased precision in the head processing, have been made to largely improve areal density. A further improvement in the areal density is expected. Generally, the magnetic recording medium is provided with recording layers on both surfaces.

However, many problems including the limitation of the head processing, side fringes caused by broadening of a magnetic field, crosstalk, and the like are made apparent. Thus, the improvement in the areal density by the conventional improvement approach has reached the limit. Therefore, as a candidate of a magnetic recording medium that enables further improvement in the areal density, a discrete type magnetic recording medium in which a continuous recording layer is divided into a number of divided recording elements has been proposed (referring to Japanese Patent Laid-Open Publication No. Hei 9-97419, for example).

As a processing technique for achieving fine division of the continuous recording layer, as dry etching processes, ion beam etching, and reactive ion etching using CO (carbon monoxide) gas with a nitrogen-containing gas such as NH₃ (ammonia) gas added thereto as a reactive gas can be used (referring to Japanese Patent Laid-Open Publication No. Hei 12-322710, for example).

As a technique for processing a mask layer for dry etching in a predetermined pattern, techniques used in the art of semiconductor manufacturing, such as lithography using a resist layer, can be used.

### DISCLOSURE OF THE INVENTION

However, there was no conventional magnetic recording medium in which the recording layers on both surfaces were processed, like a discrete type-magnetic recording medium. When process such as dry etching was actually performed for the continuous recording layers or the like on both surfaces, warpage of the magnetic recording medium occurred in some cases. In addition, warpage occurred in deposition of the continuous recording layers and the like in other cases. The reason for the above is considered as follows. A magnetic recording medium is a thin plate. Thus, even if deposition or process is performed on the order of nanometers, uneven stress is generated in the thickness direction, thus causing warpage. Moreover, it is considered that heat generated in dry etching also contributes to occurrence of warpage.

In order to achieve stable flying of a head, it is preferable that the surface of the magnetic recording medium be flat. However, because of the aforementioned warpage, the head flying may be unstable in some cases.

In the case where a conventional dry etching technique such as reactive ion etching is used, it is possible to divide the continuous recording layer into a number of divided recording elements in a fine pattern. However, in this case, precision in the processing of divided recording elements may vary depending on a position on the magnetic recording medium or the divided recording elements may be overheated and magnetically degraded. Moreover, a step portion like a burr may be formed along the peripheral portion of the divided recording element or the divided recording element may be formed to have tapered side faces. In other words, a certain degree of misalignment may occur between a desired shape and an actually processed shape. Because of the magnetic degradation and the misalignment of the processed shape of the divided recording element as described above, desired magnetic characteristics are not be achieved in some cases.

For example, in reactive ion etching, a distribution of plasma tends to be unstable near an end of an object to be processed, and the precision in the processing of the divided recording element near the end of the object to be processed tends to be lower.

In addition, reactive ion etching using as a reactive gas CO (carbon monoxide) gas or the like which is used for processing a magnetic material requires a large bias power and therefore the temperature of the object to be processed easily increases. Thus, the divided recording elements may be overheated and magnetically degraded.

The above overheating of the divided recording element can be prevented by providing a cooling apparatus. However, provision of the cooling apparatus makes the structure of the manufacturing apparatus complicated and increases the cost. Moreover, since the plasma distribution tends to be unstable near the end of the object to be processed, the temperature distribution easily becomes uneven accordingly and it is difficult to uniformly cool the object to be processed.

Moreover, in order to mass-produce a magnetic recording medium, it is desirable that a plurality of objects to be processed be arranged side by side and be processed at the same time. However, since the cooling apparatus typically includes an ESC (electrostatic chuck) and a bias application apparatus, when a plurality of objects to be processed are disposed in a line, it is difficult to provide such a cooling apparatus for the reasons of the space, the precision in the processing, and the like. Thus, it is difficult to mass-produce a discrete type magnetic recording medium by simultaneously processing a plurality of objects to be processed by reactive ion etching in which the object to be processed is to be cooled.

On the other hand, the use of ion beam etching can solve the aforementioned problems. However, in this case, there is a problem that a step portion like a burr can be easily formed along the peripheral portion of the divided recording element.

This problem is described in more detail. As shown in FIG. 21A, when an exposed portion of a continuous recording layer 100 which is not covered with a mask 102 is processed by ion beam etching, removal of the continuous recording layer 100 and re-deposition of a part of removed particles on the side face 102A of the mask 102 are repeated. The re-deposited particles are removed by ion beams sequentially when the amount of the re-deposited particles is not large. However, when the amount of the re-deposited particles is large, a part of them is deposited on the side face 102A of the mask 102, as shown in FIG. 21B, and finally forms a step portion 106 in the peripheral portion of the divided recording element 104, as shown in FIG. 21C. This phenomenon can occur in dry etching in general. Especially, this phenomenon can occur in ion beam etching significantly. In order to suppress this phenomenon, a technique is known in which ion beams or the like are made incident on a surface of an object to be processed from a direction inclined from the normal of the surface of the object to be processed, so as to efficiently remove the re-deposited particles from the side face of the object to be processed and the like. However, this technique is not effective in the case where a pattern is fine, as in a discrete type magnetic recording medium.

Furthermore, when dry etching is used, it is difficult to form a divided recording element 200 having an ideal shape in which its side face 200A stands approximately vertically, as shown in FIG. 22A. In fact, the divided recording element 200 is formed to have a tapered side face 200A, as shown in FIG. 22B.

More specifically, in dry etching, a part of gas approaches an object to be processed from a direction slightly inclined from a direction vertical to the object to be processed. Thus, an end of a region to be etched is in the shadow of mask 202 with respect to the gas that approaches the object to be processed at an angle, even if that end is not covered with the mask 202. Therefore, etching progresses more slowly at the end of the region to be etched than in other portions, resulting in the tapered side face 200A of the divided recording element 200.

In view of the foregoing problems, the present invention provides a manufacturing method and a manufacturing apparatus of a magnetic recording medium, which can efficiently manufacture the magnetic recording medium to have good magnetic characteristics while suppressing warpage of the medium, and magnetic degradation and misalignment of a processed shape of divided recording elements.

The present invention simultaneously processes both surfaces of an object to be processed in which continuous recording layers are formed on both the surfaces, thereby keeping temperature distribution and balance of stress uniform on both the surfaces so as to suppress warpage of the object to be processed.

Moreover, the present invention employs ion beam etching as a dry etching method for the continuous recording layer, thereby suppressing the process temperature of the continuous recording layer, suppressing warpage of the object to be processed and magnetic degradation of divided recording elements, and suppressing variation in the precision in the processing of the continuous recording layer depending on a position on the object to be processed.

In addition, the present invention removes a resist layer on a mask layer covering the continuous recording layer before dry etching of the continuous recording layer, so as to make a covering component on the continuous recording layer thinner. Thus, the present invention suppresses a tapered angle of a side face of the divided recording element and formation of a projection in the peripheral portion of the divided recording element.

As the material for the mask layer covering the continuous recording layer, diamond like carbon is preferable. This is because that material has a low etching rate with respect to ion beam etching and therefore can be formed to be thinner. In addition, control of the processed shape is relatively easy for diamond like carbon.

In the present specification, the term “diamond like carbon” (hereinafter, simply referred to as “DLC”) is used to mean a material that is mainly composed of carbon, has an amorphous structure, and has Vickers hardness of approximately 200 to approximately 8000 kgf/mm².

Moreover, in the present specification, the term “ion beam etching” is used to collectively mean a processing method that makes an ionized gas incident on a subject to be processed to remove the subject to be processed, such as ion milling. Please note that the term “ion beam etching” is not limited to a processing method that converges an ion beam and makes it incident on the subject to be processed.

Furthermore, in the present specification, the term “magnetic recording medium” is not limited to a hard disc, a floppy (registered trademark) disc, a magnetic tape, and the like, which use only magnetism for recording and reproducing information. This term is also used to mean a magnetooptical recording medium such as an MO (Magneto Optical), which uses magnetism and light, and a heat-assisted recording medium that uses magnetism and heat.

The foregoing object can be achieved by the invention as described below.

(1) A manufacturing method of a magnetic recording medium, for processing an object to be processed in which continuous recording layers are formed on both surfaces of a substrate to form divided recording layers each formed by a number of divided recording elements on both the surfaces of the substrate, comprising: a processing step of simultaneously processing both the surfaces of the object to be processed.

(2). The manufacturing method of a magnetic recording medium according to (1), wherein: the object to be processed includes the continuous recording layer, a mask layer, and a resist layer formed on each of the surfaces of the substrate in that order; and the manufacturing method comprises a resist layer processing step of processing the resist layer in a predetermined pattern, a mask layer processing step of processing the mask layer in the pattern based on the resist layer, and a continuous recording layer processing step of processing the continuous recording layer in the pattern based on the mask layer to divide the continuous recording layer into the number of divided recording elements; and at least one of the resist layer processing step, the mask layer processing step, and the continuous recording layer processing step is performed to simultaneously process both the surfaces of the object to be processed.

(3) The manufacturing method of a magnetic recording medium according to (2), wherein the resist layer processing step simultaneously transfers the pattern onto the resist layers on both the surfaces of the object to be processed by imprinting.

(4) The manufacturing method of a magnetic recording medium according to (2) or (3), wherein the continuous recording layer processing step simultaneously processes the continuous recording layers on both the surfaces of the object to be processed by ion beam etching.

(5) The manufacturing method of a magnetic recording medium according to any one of (2) to (4), further comprising a resist layer removal step of removing the resist layer before the continuous recording layer processing step.

(6) The manufacturing method of a magnetic recording medium according to any one of (2) to (5), wherein the material for the mask layer is diamond like carbon.

(7) The manufacturing method of a magnetic recording medium according to any one of (2) to (6), further comprising a deposition step of depositing the continuous recording layer, the mask layer, and the resist layer, wherein the deposition step simultaneously deposits at least one of the continuous recording layer, the mask layer, and the resist layer on both sides of the substrate.

(8) The manufacturing method of a magnetic recording medium according to any one of (1) to (7), wherein a plurality of the objects to be processed are processed simultaneously.

(9) The manufacturing method of a magnetic recording medium according to any one of (1) to (7), wherein all the steps are preformed to simultaneously process both the surfaces of the object to be processed.

(10) A manufacturing apparatus of a magnetic recording medium, for processing an object to be processed in which continuous recording layers are formed on both surfaces of a substrate to form divided recording layers each formed by a number of divided recording elements on both the surfaces of the substrate, comprising a processing device for simultaneously processing both the surfaces of the substrate.

(11) The manufacturing apparatus of a magnetic recording medium according to (10), comprising: a resist layer processing device for processing a resist layer of the object to be processed in a predetermined pattern, in the object the continuous recording layer, a mask layer, and the resist layer being formed on each of the surfaces of the substrate in that order; a mask layer processing device for processing the mask layer in the pattern based on the resist layer; and a continuous recording layer processing device for processing the continuous recording layer in the pattern based on the mask layer to divide the continuous recording layer into the number of divided recording elements, wherein at least one of the resist layer processing device, the mask layer processing device, and the continuous recording layer processing device is configured to simultaneously process both the surfaces of the object to be processed.

(12) The manufacturing apparatus of a magnetic recording medium according to (11), wherein the resist layer processing device is a press device which is configured to simultaneously transfer the pattern onto the resist layers on both the surfaces of the object to be processed by imprinting.

(13) The manufacturing apparatus of a magnetic recording medium according to (10) or (11), wherein the continuous recording layer processing device is an ion beam etching device which is configured to simultaneously process the continuous recording layers on both the surfaces of the object to be processed by ion beam etching.

(14) The manufacturing apparatus of a magnetic recording medium according to any one of (11) to (13), further comprising a deposition device for simultaneously depositing at least one of the continuous recording layers, the mask layers, and the resist layers on both sides of the substrate symmetrically.

(15) The manufacturing apparatus of a magnetic recording medium according to any one of (10) to (14), further comprising a holder for holding a plurality of the objects to be processed to enable simultaneous process of the plurality of objects to be processed.

(16) The manufacturing apparatus of a magnetic recording medium according to any one of (10) to (15), wherein

both the surfaces of the object to be processed are simultaneously processed in all processing steps.

According to the present invention, an excellent effect can be achieved that a magnetic recording medium having good magnetic characteristics can be efficiently and surely manufactured while warpage of the medium, magnetic degradation of divided recording elements, and misalignment of a processed shape of the divided recording elements can be suppressed.

### BRIEF DESCRIPTION OF THE DRAWINGS

FIG. 1 is a side cross-sectional view schematically showing a structure of an object to be processed as a starting body according to an exemplary embodiment of the present invention;

FIG. 2 is a side cross-sectional view schematically showing the structure of the magnetic recording medium obtained by processing the above object to be processed;

FIG. 3 is a block diagram schematically showing a manufacturing apparatus for processing the magnetic recording medium;

FIG. 4 is a perspective view generally showing a structure of a holder included in the above manufacturing apparatus;

FIG. 5 is a side cross-sectional view showing a circumferential structure of the holder;

FIG. 6 is a side view schematically showing a structure of a reactive ion etching device included in the above manufacturing apparatus;

FIG. 7 is a side view schematically showing a structure of an ion beam etching device included in the above manufacturing apparatus;

FIG. 8 is a flowchart of a manufacturing process of a magnetic recording medium;

FIG. 9 is a side cross-sectional view schematically showing the shape of the object to be processed in which a division pattern has been transferred onto a resist layer;

FIG. 10 is a side cross-sectional view schematically showing the shape of the object to be processed in which the resist layer at the bottom of grooves has been removed;

FIG. 11 is a side cross-sectional view schematically showing the shape of the object to be processed in which the second mask layer at the bottom of concave portions has been removed;

FIG. 12 is a side cross-sectional view schematically showing the shape of the object to be processed in which the first mask layer at the bottom of the grooves has been removed;

FIG. 13 is a side cross-sectional view schematically showing the shape of the object to be processed in which divided recording elements have been formed;

FIG. 14 is a side cross-sectional view schematically showing the shape of the object to be processed in which the first mask layer on the divided recording elements has been removed;

FIG. 15 is a side cross-sectional view schematically showing the shape of the object to be processed in which portions between the divided recording elements have been filled with a non-magnetic material;

FIG. 16 is a side cross-sectional view schematically showing the shape of the object to be processed in which the surfaces of the divided recording elements and the non-magnetic material have been flattened;

FIG. 17 is a microphotograph showing a shape of a divided recording element of a magnetic recording disc according to Example of the present invention while enlarging it;

FIG. 18 is a graph showing a relationship between a distance from an end of a magnetic recording disc and an etching rate of a continuous recording layer for each of the above magnetic recording disc and a magnetic recording disc of Comparative Example 1;

FIG. 19 shows an MFM image of the magnetic recording medium of Example of the present invention;

FIG. 20 shows an MFM image of the magnetic recording medium of Comparative Example 1;

FIG. 21 is a side cross-sectional view schematically showing a formation process of the divided recording elements on a step portion in the peripheral portion by a conventional dry etching technique; and

FIG. 22 is a side cross-sectional view schematically showing an actual formation process of the divided recording elements being formed to have a tapered side surface by the conventional dry etching technique.

### BEST MODE FOR CARRYING OUT THE INVENTION

Various exemplary embodiments of this invention will be hereinafter described in detail with reference to the drawings.

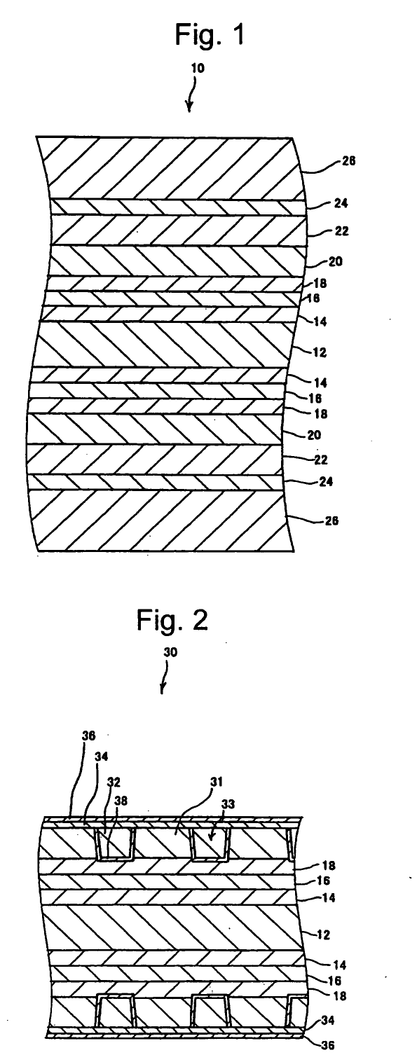

The present exemplary embodiment relates to a manufacturing method of a magnetic recording medium, which processes an object to be processed as a starting body of a magnetic recording medium shown in FIG. 1, by dry etching or the like so as to process a continuous recording layer in a shape of a servo pattern (not shown) including a predetermined line and space pattern, as shown in FIG. 2, and contact holes, thereby dividing the continuous recording layers on both surfaces into a number of divided recording elements. The present exemplary embodiment has features in a technique for processing the continuous recording layer, materials for a mask layer and a resist layer which cover the continuous recording layer, techniques for processing those layers, and the like. Moreover, the present exemplary embodiment has a feature in a manufacturing apparatus of a magnetic recording medium for performing the above processing techniques of the continuous recording layer and the like to mass-produce the magnetic recording medium. Except for those points, the manufacturing method and the manufacturing apparatus of the present exemplary embodiment are the same as a conventional manufacturing method of a magnetic recording medium and a conventional manufacturing apparatus of the same. Thus, the description is omitted in an appropriate manner.

An object to be processed 10 is an approximately circular disc having a central hole (not shown). As shown in FIG. 1, the object to be processed 10 includes a glass substrate 12 and an underlayer 14, a soft magnetic material layer 16, a seed layer 18, a continuous recording layer 20, a first mask layer 22, a second mask layer 24, and a resist layer 26 formed on the glass substrate 12 in that order.

The underlayer 14 is made of Cr (chrome) or a Cr alloy. The soft magnetic material layer 16 is made of an Fe (iron) alloy or a Co (cobalt) alloy. The seed layer 18 is made of CoO, MgO, NiO, or the like. The continuous recording layer 20 is made of a Co (cobalt) alloy. The first mask layer 22 is made of DLC. The second mask layer 24 is made of Si (silicon). The resist layer 26 is made of a negative resist (NEB22A manufactured by Sumitomo Chemical Co., Ltd.).

As shown in FIG. 2, a magnetic recording medium 30 is a perpendicular recording, discrete track type magnetic disc. In the magnetic recording medium 30, the aforementioned continuous recording layers 20 on both surfaces are divided into a number of divided recording elements 31 at fine intervals in a radial direction of tracks. Groove portions 33 between the divided recording elements 31 are filled with a non-magnetic material 32. On the divided recording elements 31 and the non-magnetic material 32, a protection layer 34 and a lubricating layer 36 are formed in that order. In addition, a barrier 38 is formed between the divided recording elements 31 and the non-magnetic material 32.

The non-magnetic material 32 is SiO₂ (silicon dioxide). The protection layer 34 and the barrier 38 are formed by layers of the aforementioned hard carbon called as DLC. The material for the lubricating layer 34 is PFPE (perfluoropolyether).

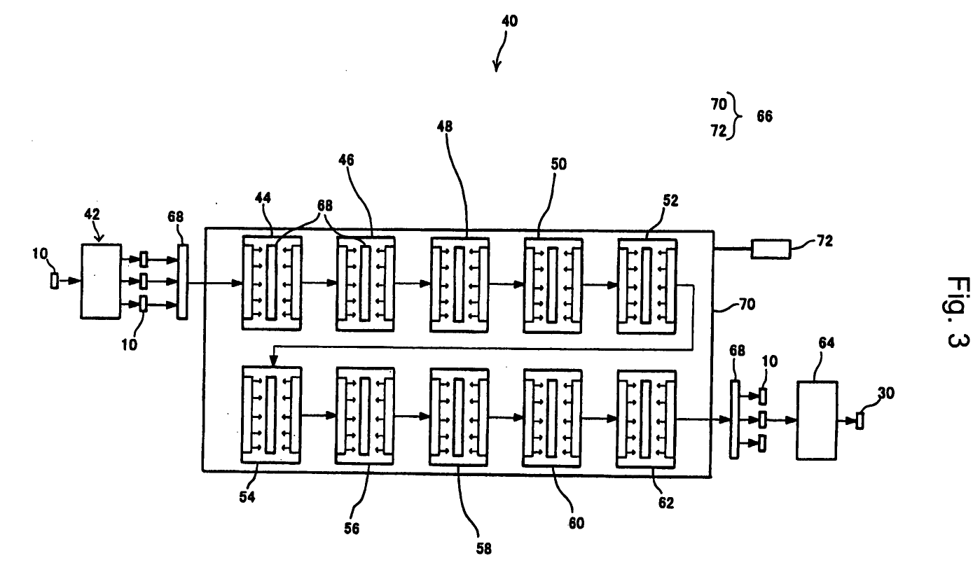

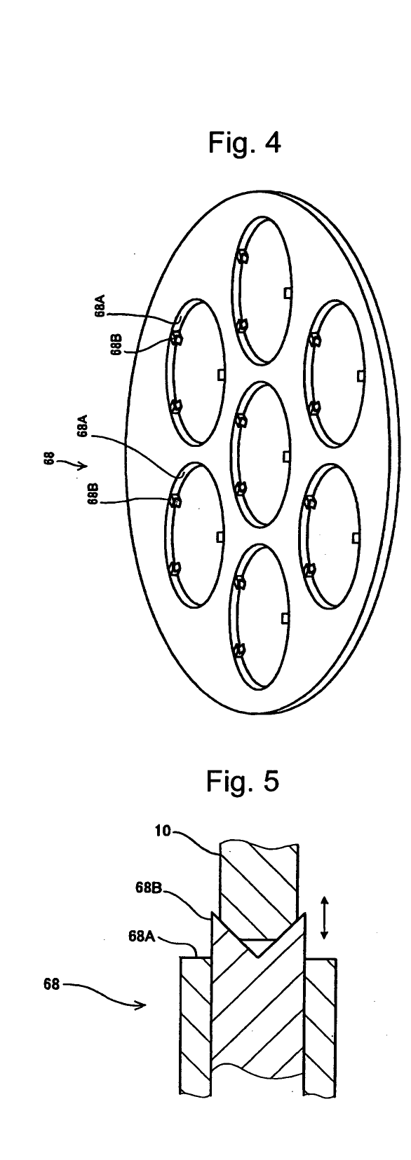

As shown in FIG. 3, a manufacturing apparatus 40 of a magnetic recording medium includes a transfer device 42, an ashing device 44, reactive ion etching devices 46 and 48, an ion beam etching device 50, an ashing device 52, a dry cleaning device 54, a barrier formation device 56, a non-magnetic material filling device 58, a flattening device 60, a protection layer formation device 62, and a lubricating layer formation device 64 for forming the lubricating layer 36. Each of the above-listed processing devices is configured to simultaneously process both surfaces of the object to be processed 10.

The manufacturing apparatus 40 also includes a vacuum keeping device 66 for accommodating the ashing device 44, the reactive ion etching devices 46 and 48, the ion beam etching device 50, the ashing device 52, the dry cleaning device 54, the barrier formation device 56, the non-magnetic material filling device 58, the flattening device 60, and the protection layer formation device 62 and for keeping the surrounding of an object to be processed 10 in a vacuum state.

Moreover, the manufacturing apparatus 40 includes a holder 68 for holding a plurality of objects to be processed 10 simultaneously, as shown in FIG. 4, and an automating transport device (not shown) for automatically transporting the holder 68. Thus, the manufacturing apparatus 40 can simultaneously process a plurality of objects to be processed 10.

The transfer device 42 is a press device for pressing a mold (not shown) produced by lithography or the like onto the resist layers 26 on both surfaces of the object to be processed 10 simultaneously, so as to transfer a pattern onto the resist layers 26 and form grooves. The transfer device 42 uses a nano-imprinting method.

The ashing device 44 is configured to remove the resist layer 26 at the bottom of the grooves that is left after nano-imprinting, by ashing using oxygen, ozone, or plasma of oxygen or ozone.

The reactive ion etching device 46 is configured to remove the second mask layer 24 at the bottom of the grooves by reactive ion etching using a fluorinated gas such as CF₄ (carbon tetrafluoride) gas or SF₆ (sulfur hexafluoride) gas as a reactive gas.

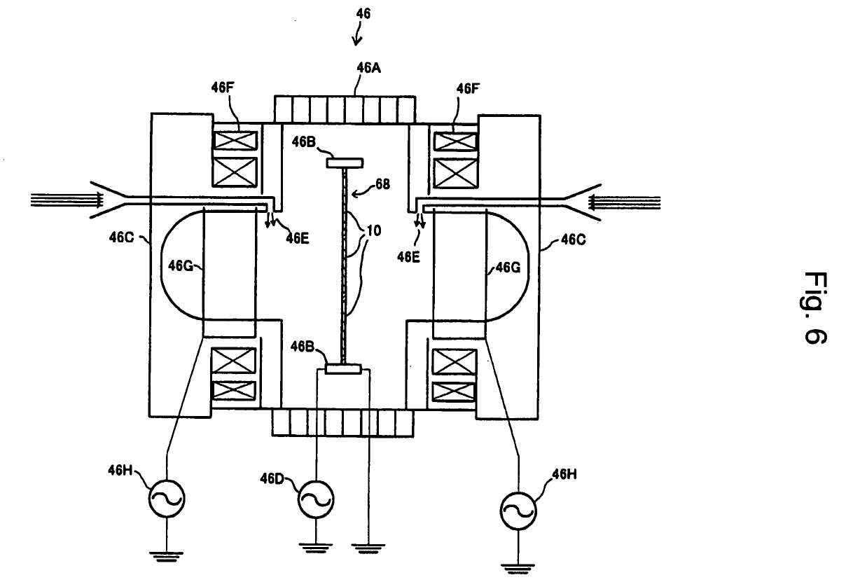

More specifically, as shown in FIG. 6, the reactive ion etching device 46 is a helicon wave plasma type device and includes a diffusion chamber 46A, an ESC (electrostatic chuck) stage electrode 46B for placing the holder 68 within the diffusion chamber 46A, and quartz bell jars 46C that are provided on both sides of the diffusion chamber 46A in the horizontal direction for generating plasma.

The stage electrode 46B is configured to support at its outer peripheral portion the holder 68 of a circular disc shape, so as to hold the holder 68 in an approximately vertical posture. To the stage electrode 46B, a bias supply 46D for applying a bias voltage is connected by wiring. The bias supply is an AC power source having a frequency of 1.6 MHz.

The quartz bell jar 46C has an opening at its lower end, which faces the inside of the diffusion chamber 46A. In a lower part of the quartz bell jar 46C, a gas supply hole 46E for supplying a reactive gas is provided. Moreover, an electromagnetic coil 46F and an antenna 46G are provided around the quartz bell jar 46C. To the antenna 46G, a plasma-generating power supply 46H is connected by wiring. The plasma-generating power supply 46H is an AC power source having a frequency of 13.56 MHz.

The reactive ion etching device 48 is configured to remove the resist layer 26 in regions other than the grooves on both surfaces of the object to be processed 10, by reactive ion etching using oxygen or ozone as a reactive gas and to remove the first mask layer 22 at the bottom of the grooves on both surfaces of the object to be processed 10. Please note that the reactive ion etching device 48 has the same structure as the reactive ion etching device 46, although they use different types of reactive gas.

The ion beam etching device 50 is configured to remove the continuous recording layer 20 at the bottom of the grooves on both surfaces of the object to be processed 10 by ion beam etching using Ar (argon) gas, thereby dividing the continuous recording layer 20 into a number of divided recording elements 31.

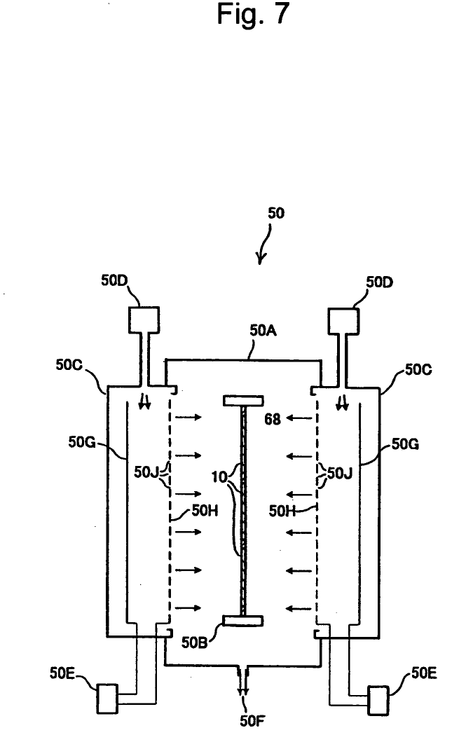

More specifically, as shown in FIG. 7, the ion beam etching device 50 includes a vacuum chamber 50A, an ESC (electrostatic chuck) stage electrode 50B for placing the holder 68 within the vacuum chamber 50A, an ion gun 50C for generating ions and making them incident on the stage electrode SOB, a gas supply part 50D for supplying argon gas to the ion gun 50C, and a power supply 50E for applying a beam voltage to the ion gun 50C. The vacuum chamber 50A is provided with an exhaust hole 50F for discharging argon gas.

The stage 50B is configured to support at its outer peripheral portion the holder 68 of a circular disc shape, so as to hold the holder 68 in the approximately vertical posture.

The ion gun 50C includes an anode 50G connected to the power supply 50E by wiring, and a cathode 50H. The cathode 50H is provided with a number of fine holes 50J through which ionized argon gas is radiated and emitted toward both surfaces of the holder 68.

The ashing device 52 is configured to remove the first mask layer 22 remaining on the divided recording elements 31 on both surfaces of the object to be processed 10 by ashing using oxygen, ozone, or plasma of oxygen or ozone.

The dry cleaning device 54 is configured to remove foreign particles around the divided recording elements 31 on both surfaces of the object to be processed 10 by using plasma.

The barrier formation device 56 is a CVD device for forming the barrier 38 of DLC on the divided recording elements 31 on each of the surfaces of the object to be processed 10 by CVD (Chemical Vapor Deposition).

The non-magnetic material filling device 58 is a bias sputtering device for filling the groove portions 33 between the divided recording elements 31 with a non-magnetic material 32 of SiO₂ by bias sputtering.

The flattening device 60 is an ion beam etching device for flattening a surface of a medium by ion beam etching using Ar gas.

The protection layer formation device 62 is a CVD device for forming the protection layer 34 of DLC by CVD on the divided recording elements 31 and the non-magnetic material 32.

The lubricating layer formation device 64 is a dipping device for applying the lubricating layer 36 of PFPE by dipping onto the protection layer 34.

The vacuum keeping device 66 is configured to include a vacuum chamber 70 and a vacuum pump 72 that is in communication with the vacuum chamber 70.

The holder 68 is an approximately circular disc in which a plurality of circular through holes 68A each holding an object to be processed 10 are formed. On the inner circumference of each circular through hole 68A, three holding members 68B each of which is freely movable in the radial direction are provided at three positions at circumferentially equal intervals, respectively. Thus, the holding member 68B holds the object to be processed 10 at three portions on its outer circumference. More specifically, the holding member 68B has a V-shaped groove at its top end and comes into contact with the outer circumference of the object to be processed 10 at that V-shaped end. In this manner, the holding member 68B restrains and holds the object to be processed 10 in the thickness direction and the radial direction. Moreover, the holder 68 is made of a conductive material and can be used as an electrode for reactive ion etching.

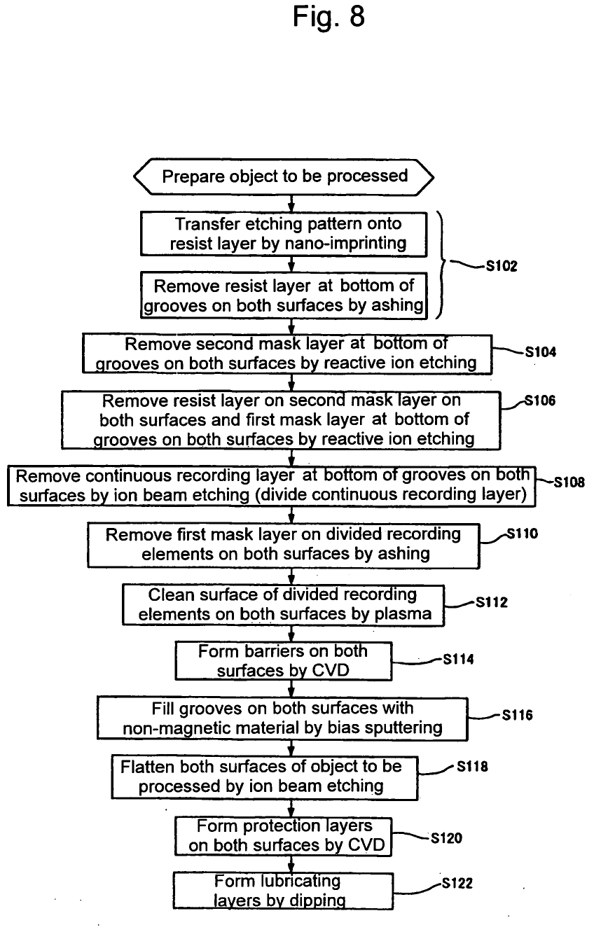

Next, an operation of the manufacturing apparatus 40 of a magnetic recording medium is described, referring to the flowchart shown in FIG. 8, and the like.

First, an object to be processed 10 is prepared. The object to be processed 10 is obtained by forming the underlayer 14 having a thickness of 30 to 2000 nm, the soft magnetic material layer 16 having a thickness of 50 to 300 nm, the seed layer 18 having a thickness of 3 to 30 nm, the continuous recording layer 20 having a thickness of 5 to 30 nm, the first mask layer 22 having a thickness of 3 to 20 nm, and the second mask layer 24 having a thickness of 3 to 15 nm on the glass substrate 12 by sputtering in that order and then forming the resist layer 26 having a thickness of 30 to 300 nm on the second mask layer 24 by spin-coating or dipping. It is preferable that the first mask layer 22 be thinner than the continuous recording layer 20. For example, in the case where the continuous recording layer 20 has a thickness of about 20 nm, it is preferable that the first mask layer 22 be formed to have a thickness of 15 nm or less.

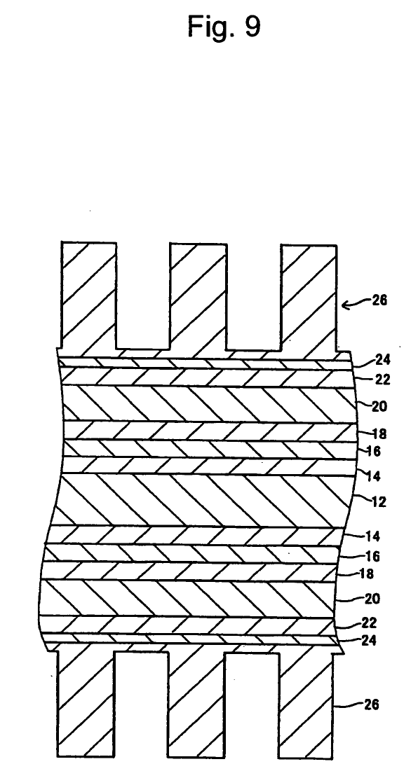

Onto the resist layers 26 on both surfaces of the object to be processed 10, grooves corresponding to a division pattern of the divided recording elements 31, shown in FIG. 9, are transferred by imprinting by means of the transfer device 42. The transfer is performed for both the surfaces of the object to be processed 10 simultaneously. By the use of imprinting, it is possible to efficiently transfer the grooves corresponding to the division pattern onto the object to be processed 10.

Alternatively, the grooves corresponding to the division pattern can be transferred onto the resist layer 26 by lithography or the like. However, using imprinting can allow the structure of the transfer device for simultaneously forming grooves on the resist layers 26 on both surfaces of the object to be processed 10 to be made simple. Then, a plurality of objects to be processed 10 in each of which the grooves have been formed in the aforementioned manner are attached to the holder 68, and the holder 68 is transported into the vacuum chamber 70 while being kept in an approximately vertical posture. The thus transported holder 68 is automatically transported to various processing devices in the vacuum chamber 70 by means of a transport device (not shown), while being kept in an approximately vertical posture. Thus, both surfaces of the plurality of objects to be processed 10 are simultaneously processed.

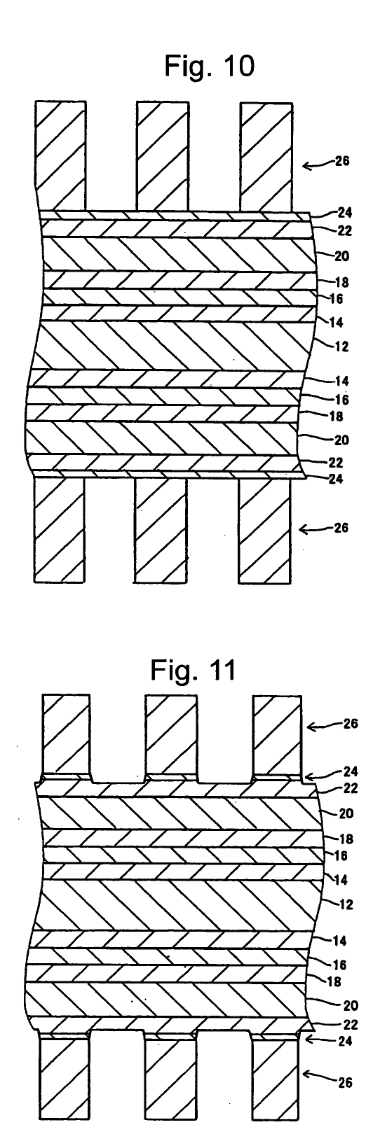

First, the ashing device 44 removes the resist layer 26 at the bottom of the grooves on each of the surfaces of the object to be processed 10, as shown in FIG. 10 (S102). Although the resist layer 26 is also removed in regions other than the grooves, the resist layer 26 corresponding to steps between the grooves and those regions is left in those regions.

Then, the reactive ion etching device 46 removes the second mask layer 24 at the bottom of the grooves on both surfaces of the object to be processed 10, as shown in FIG. 11 (S104). In this step, the first mask layer 22 is also removed slightly. In addition, the resist layer 26 in the regions other than the grooves is also removed slightly, but it is left. Since the process of the second mask layer 24 uses a fluorinated gas as a reactive gas, it does not always require wet cleaning using water or the like, unlike a case in which a chlorinated gas is used as a reactive gas. That is, dry cleaning is sufficient, which will be described later. Therefore, all the steps for processing the object to be processed 10 can be achieved by dry processes, thus improving the production efficiency.

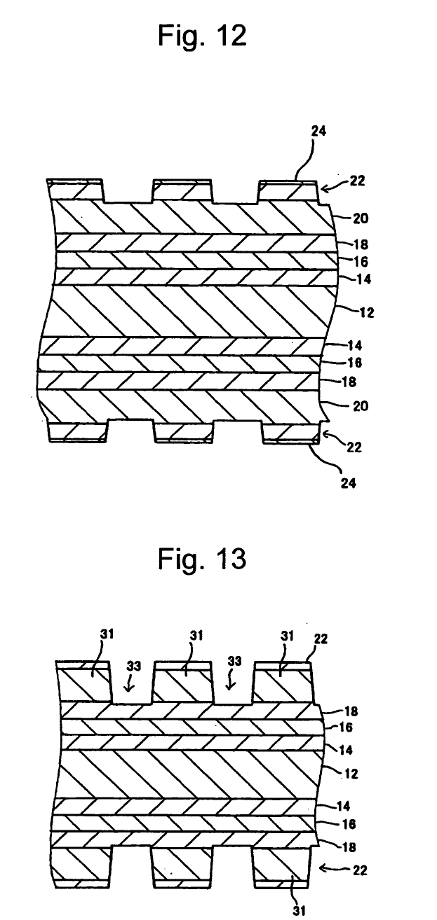

Then, the reactive ion etching device 48 removes the first mask layer 22 at the bottom of the grooves and removes the resist layer 26 in the regions other than the grooves, as shown in FIG. 12 (S106). Although the second mask layer 24 in the regions other than the grooves is also removed slightly, the most part of the second mask layer 24 is left in those regions. The first mask layer 22 is made of DLC, and the resist layer 26 is made of a resin resist material. Both of those materials have high etching rates with respect to reactive ion etching using oxygen as a reactive gas. Thus, the removal of the first mask layer 22 at the bottom of the grooves and the removal of the resist layer 26 in the regions other than the grooves can simultaneously be performed. Therefore, good production efficiency is achieved.

Moreover, since the second mask layer 24 made of silicon that has a low etching rate with respect to reactive ion etching using oxygen as a reactive gas is formed on the first mask layer 22, the first mask layer 22 in the regions other than the grooves is left in a good shape.

As described above, by providing two mask layers, i.e., the first and the second mask layers 22 and 24, it is possible to expand the range of choices for the mask materials and the type of reactive gas.

Next, the ion beam etching device 50 removes the continuous recording layer 20 at the bottom of the grooves on both surfaces of the object to be processed 10, as shown in FIG. 13, so that the continuous recording layer 20 is divided into a number of recording elements 31 and groove portions 33 are formed between the divided recording elements 31 (S108).

In this step, the second mask layer 24 in the regions other than the grooves is completely removed and the most part of the first mask layer 22 in those regions is also removed. However, the small amount of the first mask layer 22 can be left on the upper surface of the divided recording elements 31.

The first mask layer 22 has a lower etching rate with respect to ion beam etching than that of the continuous recording layer 20 because the first mask layer 22 is made of DLC. This allows the first mask layer 22 to be formed more thinly. Moreover, the second mask layer 24 is made of silicon and has a higher etching rate with respect to ion beam etching than that of the continuous recording layer 20. Thus, the second mask layer 24 can be removed in a short time. However, even in the case where the second mask layer 24 is made of a material having an etching rate with respect to ion beam etching that is approximately equal to or lower than that of the continuous recording layer 20, the second mask layer 24 can be removed in a short time if it is formed to have the minimum thickness in the range that enables the second mask layer 24 to be left in the step of removing the resist layer and processing the first mask layer (S106). Furthermore, the resist layer 26 on the second mask layer 24 has already been removed. That is, the covering component that covers the continuous recording layer 20 has become substantially thinner. Thus, an area in the shadow of ion beams incident from a direction inclined from the normal of the surface of the object to be processed 10 is small. Accordingly, a tapered angle of the side face of each divided recording element 31 can be suppressed.

In addition, since the covering component covering the continuous recording layer 20 has become thin, the amount of particles that are re-deposited on the side faces of the covering component in ion beam etching is small. Thus, formation of an edge-like step portion in the peripheral portion of the divided recording element 31 can be prevented or reduced. Moreover, if the thickness of the first mask layer, a setting condition of ion beam etching, and the like are adjusted so as to make the remaining amount of the first mask layer 22 on the divided recording elements 31 as small as possible, it is possible to further reduce the particles re-deposited on the side faces of the first mask layer and further suppress the formation of the edge-like step portion in the peripheral portion of the divided recording element 31.

In ion beam etching, the process precision is less sensitive to the shape of the object to be processed 10, as compared with that in reactive ion etching. Therefore, ion beam etching can uniformly process the entire region of every object to be processed 10 with high precision.

Moreover, in ion beam etching, the process temperature is lower than that in reactive ion etching using CO gas or the like as a reactive gas. Thus, magnetic degradation of the divided recording elements 31 caused by overheating can be prevented or reduced.

In addition, the process temperature in ion beam etching is low. Thus, ion beam etching does not require a cooling apparatus for supplying refrigerant to the side of the object to be processed 10, which is not being processed. In other words, by using ion beam etching, the continuous recording layers 20 on both surfaces of the object to be processed 10 can be processed simultaneously.

Furthermore, in ion beam etching, etching for magnetic material progresses faster and the etching rate with respect to a fine pattern is less dependent on the shape, as compared with that in reactive ion etching using CO gas or the like as reactive gas. Thus, ion beam etching provides good production efficiency.

Please note that, when the continuous recording layer 20 is processed, the seed layer 18 is also removed slightly.

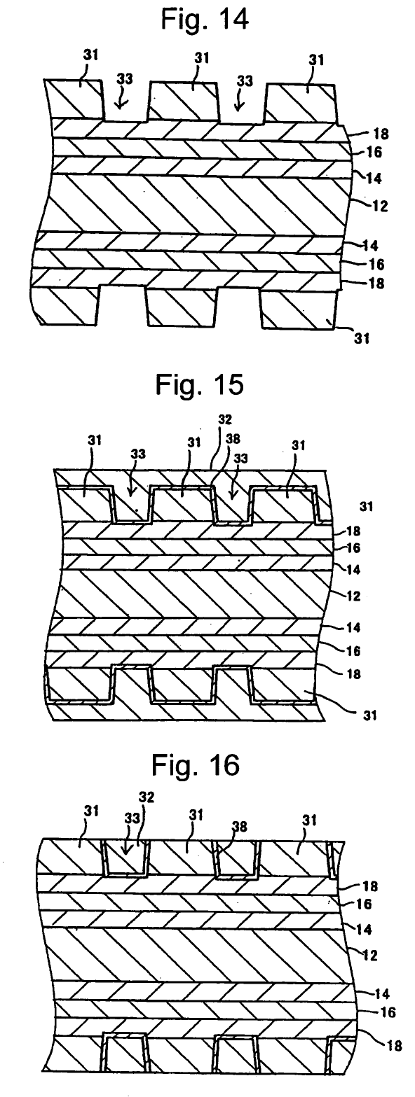

Next, the ashing device 52 completely removes the first mask layer 22 remaining on the divided recording elements 31, as shown in FIG. 14 (S110).

Then, by using the dry cleaning device 54, foreign objects on the surface of the divided recording elements 31 are removed (S112).

Then, as shown in FIG. 15, the barrier formation device 56 deposits the barrier 38 of DLC on the divided recording elements 31 to have a thickness of 1 to 20 nm (S114), and the non-magnetic material filling device 58 fills the groove portions 33 between the divided recording elements 31 with a non-magnetic material 32 (S116). Please note that the non-magnetic material 32 is deposited to completely cover the barrier 38. The divided recording elements 31 are not damaged by bias sputtering of the non-magnetic material 32 because they are covered and protected by the barrier 38.

Then, the flattening device 60 removes the non-magnetic material 32 to the upper surface of the divided recording elements 31, as shown in FIG. 16, so that the surfaces of the divided recording elements 31 and the non-magnetic material 32 are flattened (S118). In this step, in order to perform flattening with high precision, it is preferable that an incident angle of Ar ions be set to fall within a range of from −10° to 15°. On the other hand, in the case where good flatness of the surfaces of the divided recording elements 31 and the non-magnetic material 32 has already been achieved in the non-magnetic material filling step, the incident angle of Ar ions may be set to fall within a range of from 30° to 90°. By doing so, the processing rate can be increased to improve the production efficiency. Please note that the term “incident angle” is used to mean an incident angle with respect to the surface of the object to be processed and an angle formed by the surface of the object to be processed and the central axis of ion beams. For example, when the central axis of ion beams is parallel to the surface of the object to be processed the incident angle is 0°. Please note that the barrier 38 on the divided recording elements 31 may be removed completely or partially. On the other hand, the non-magnetic material 32 on the upper surface of the divided recording elements 31 are completely removed.

Then, the protection layer formation device 62 forms the protection layer 34 of DLC to have a thickness of 1 to 5 nm on the upper surfaces of the divided recording elements 31 and the non-magnetic material 32 (S120). Then, the holder 68 is transported to the outside of the vacuum chamber 70, and the respective objects to be processed 10 are detached from the holder 68.

Furthermore, the lubricating layer 36 of PFPE is applied to have a thickness of 1 to 2 nm on the protection layer 34 by dipping using the lubricating layer formation device 64. In this way, the magnetic recording medium 30 shown in FIG. 2 is completed.

As described above, the object to be processed 10 is processed in such a manner that both surfaces thereof are simultaneously processed. Thus, temperature distribution and balance of stress are kept uniform on both surfaces and therefore warpage of the object to be processed 10 is suppressed.

Moreover, since the continuous recording layer 20 is processed by ion beam etching which is less dependent on the shape of the object to be processed, each divided recording element 31 can be uniformly processed in a good shape, irrespective of the portion on the object to be processed 10. Please note that no step portion is formed in the peripheral portion of the divided recording element 31 even if ion beam etching is used, because the covering component on the continuous recording layer 20 is substantially thin. Even if the step portion is formed, the size of the step portion can be suppressed to be negligible small.

Since the covering component on the continuous recording layer 20 is substantially thin, the divided recording element 31 can be processed to have a good shape in which the tapered angle of the side face is small.

In particular, the first mask layer is made of DLC and therefore the thickness thereof can be made thinner. Thus, the process precision of the divided recording elements can be improved.

Moreover, the continuous recording layer 20 is processed by ion beam etching and the process temperature is suppressed. Also from those reasons, warpage of the object to be processed 10 can be suppressed. The magnetic degradation of the divided recording elements 31 can be also prevented or reduced.

Since formation and the like of the divided recording elements 31 are performed in a state in which the surrounding of the object to be processed 10 is kept vacuum, oxidation, corrosion, and the like caused by the process hardly occur. Also from that reason, the degradation of the divided recording elements 31 can be prevented or reduced.

In other words, the manufacturing apparatus 40 of a magnetic recording medium can manufacture the divided recording elements 31 having a good shape and good magnetic characteristics in the magnetic recording medium 30, while suppressing the magnetic degradation of the divided recording elements 31. Thus, the manufacturing apparatus 40 is highly reliable.

Moreover, the manufacturing apparatus 40 of a magnetic recording medium processes both surfaces of the object to be processed 10 simultaneously. Thus, the manufacturing apparatus 40 provides good production efficiency.

Furthermore, the manufacturing apparatus 40 of a magnetic recording medium includes the holder 68 and processes a plurality of objects to be processed 10 simultaneously. Thus, the production efficiency is further improved.

As described above, by using ion beam etching for processing the continuous recording layer 20, it is possible to uniformly process the object to be processed with high precision while suppressing magnetic degradation. Moreover, when the process temperature of the continuous recording layer 20 is high, a cooling apparatus is needed to limit the magnetic degradation. On the other hand, when a plurality of objects to be processed are simultaneously processed, it is difficult to provide a cooling apparatus including an ESC (electrostatic chuck) and a bias application apparatus due to the space, process precision, and the like. However, when ion beam etching is used for processing the continuous recording layer 20, the process temperature of the continuous recording layer 20 can be lowered, thus eliminating the need of such a cooling apparatus. Therefore, it is possible to simultaneously process a plurality of objects to be processed with high precision. This enables mass-production of a discrete type magnetic recording medium.

Since all the steps are dry processes, transport and the like of the object to be processed are performed more easily, as compared with a manufacturing process that includes a wet process and a dry process. Thus, the manufacturing apparatus 40 provides good production efficiency for that reason.

In the present exemplary embodiment, both surfaces of the object to be processed 10 are simultaneously processed from the imprinting step for the resist layer 26 to the step of forming the protection layer 34. However, the present invention is not limited thereto. By processing both surfaces of the object to be processed 10 simultaneously in at least one of those steps, the effects of suppressing warpage of the magnetic recording medium 30 and improving the production efficiency can be achieved, even if one of surfaces of the object to be processed 10 is processed at a time in the remaining steps.

On the other hand, also in the steps of depositing the continuous recording layer 20, the first mask layer 22, the second mask layer 24, and the resist layer 26 on the glass substrate 12, the use of a deposition device that can simultaneously perform deposition on both surfaces of the glass substrate 12 can further suppress warpage of the magnetic recording medium 30 and can further improve the production efficiency.

Moreover, also in the step of forming the lubricating layer 36, simultaneous formation of the lubricating layers 36 on both surfaces of the object to be processed 10 can further suppress warpage of the magnetic recording medium 30 and can further improve the production efficiency.

In the present exemplary embodiment, the manufacturing apparatus 40 includes the holder 68 and simultaneously processes a plurality of objects to be processed 10. However, the present invention is not limited thereto. The objects to be processed 10 may be processed one by one. In this case, the effects of suppressing warpage of the magnetic recording medium 30 and improving the production efficiency can be achieved by simultaneously processing both surfaces of the object to be processed 10.

In the present exemplary embodiment, the first mask layer 22 is formed of DLC. However, the present invention is not limited thereto. The first mask layer 22 may be made of another material as long as it has a low etching rate with respect to ion beam etching.

In the present exemplary embodiment, two mask layers, i.e., the first and second mask layers 22 and 24 are formed on the continuous recording layer 20. However, the present invention is not limited thereto. The second mask layer may be omitted to achieve a mask layer having a single layer structure, as long as a material having a low etching rate with respect to both ion beam etching and the resist layer removal step is chosen as the material for the first mask layer 22.

In the present exemplary embodiment, the resist layer 26 remaining in the regions other than the grooves is removed by reactive ion etching before the continuous recording layer processing steps. However, the present invention is not limited thereto. The resist layer 26 may be removed by another dry etching technique, or may be removed by being dissolved in a dissolving agent. In the latter case, if a material having a low etching rate with respect to that dissolving agent is chosen as the material for the first mask layer 22, the second mask layer may be omitted to achieve a mask layer having a single layer structure.

In the present exemplary embodiment, the continuous recording layers 20 on both surfaces of the object to be processed 10 are simultaneously processed by ion beam etching. However, the present invention is not limited thereto. For example, the continuous recording layers 20 on both surfaces of the object to be processed 10 may be simultaneously processed by another dry etching technique, such as reactive ion etching. In this case, it is preferable to choose a technique that can make the process temperature as low as possible.

In the present exemplary embodiment, the first mask layer 22 is removed after the process of the continuous recording layer 20. However, the present invention is not limited thereto. The first mask layer 22 may be used as a part of the protection layer 34 without removing the first mask layer 22.

In the present exemplary embodiment, the underlying layer 14 and the soft magnetic layer 16 are formed under the continuous recording layer 20. However, the present invention is not limited thereto. The structure under the continuous recording layer 20 may be appropriately changed depending on the type of magnetic recording medium. For example, one of the underlying layer 14 and the soft magnetic layer 16 may be omitted. Moreover, the continuous recording layer may be formed directly on the substrate.

In the present exemplary embodiment, the material for the magnetic thin layer 16 is a CoCr alloy. However, the present invention is not limited thereto. The present invention can be applied to manufacturing of a magnetic recording medium including a divided recording layer made of another alloy containing an iron group element (Co, Fe (iron), or Ni) or formed by a multilayer structure of those elements, for example.

In the present exemplary embodiment, the magnetic recording medium 30 is a perpendicular recording, discrete track type magnetic disc in which the divided recording elements 31 are arranged side by side at fine intervals in the track-radial direction. However, the present invention is not limited thereto. The present invention can be also applied to manufacturing of a magnetic disc in which divided recording elements are arranged side by side at fine intervals in the circumferential direction of tracks (sector direction), a magnetic disc in which divided recording elements are arranged side by side at fine intervals both in the radial direction and the circumferential direction of tracks, and a magnetic disc in which divided recording elements are arranged spirally. Moreover, the present invention can be applied to manufacturing of a magnetooptical disc such as an MO, a heat-assisted recording disc that uses magnetism and heat, and other discrete type magnetic recording media having shapes different from a disc-like shape, such as a magnetic tape.

In the present exemplary embodiment, the manufacturing apparatus 40 of a magnetic recording medium includes separate processing devices for the respective steps. However, the present invention is not limited thereto. Alternatively, a single device may perform processes in two or more steps. For example, the step of removing the resist layer 26 at the bottom of the grooves and the step of removing the first mask layer 22 remaining on the divided recording elements 31 may be performed by the same ashing device. Moreover, the step of processing the continuous recording layer 20 and the step of flattening the divided recording element 31 and the non-magnetic material 32 may be performed by the same ion beam etching device using Ar gas. Furthermore, the process of the second mask layer 24, the process of the first mask layer 22, and the removal of the resist layer 26 may be performed by using the same reactive ion etching device while changing a reactive gas. By doing so, the manufacturing apparatus can be made compact, and the cost of the manufacturing apparatus can be reduced.

### EXAMPLE

In the manner described in the above exemplary embodiment, the continuous recording layers 20 on both surfaces of the object to be processed 10 were simultaneously processed, and the magnetic recording disc was manufactured. The thickness of the continuous recording layer 20 was approximately 20 nm, the thickness of the first mask layer 22 was approximately 10 nm, the thickness of the second mask layer 24 was approximately 5 nm, and the thickness of the resist layer 26 was approximately 100 nm.

For each of the processes of the second mask layer, the first mask layer, and the continuous recording layer, the process temperature of the object to be processed and the time required for the process are shown below.

The second mask layer: 50° C. or less, approximately 5 seconds (Reactive gas: SF₆)

The first mask layer: 50° C. or less, approximately 10 seconds (Reactive gas: O₂)

The continuous recording layer: approximately 120° C. or less, approximately seconds (Ar ion beams)

The manufactured magnetic recording disc had a diameter of approximately 2.5 inches. Warpage of that magnetic recording disc was approximately 3 μm or less. Thus, it was confirmed that warpage was suppressed to a level at which good head flying could be achieved.

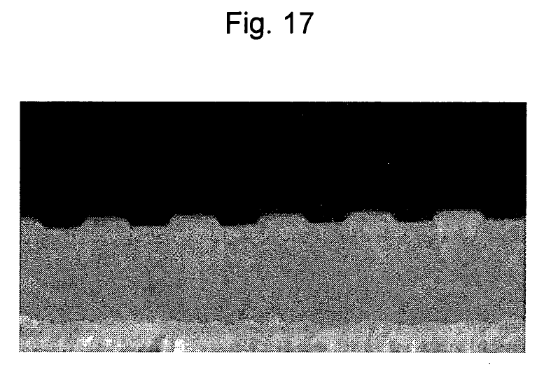

FIG. 17 is a microphotograph showing the shape of the divided recording element of that magnetic recording disc while enlarging it. It was confirmed that no edge-like step portion was formed in the peripheral portion of each divided recording element, the tapered angle of the side face of each divided recording element was suppressed, and each divided recording element was processed in a good shape.

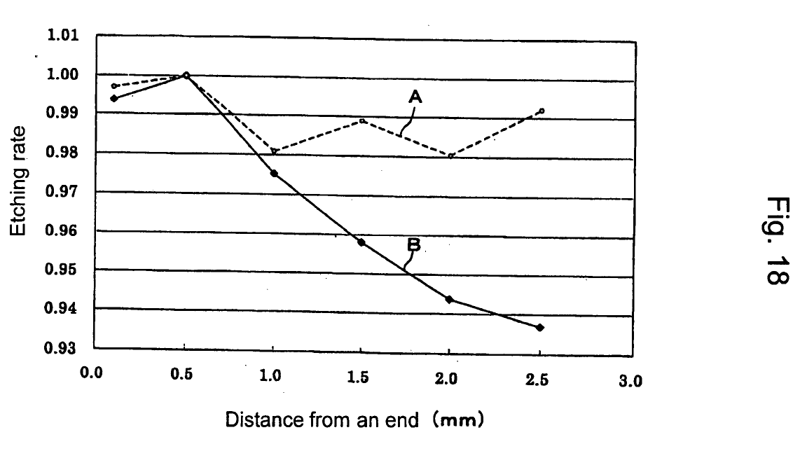

The relationship between the distance from the end of the magnetic recording disc and the etching rate of the continuous recording layer is shown with Curve A in FIG. 18. Although the etching rate of the continuous recording layer varied slightly, the tendency for the etching rate to increase or decrease with increase or decrease of the distance from the end was not found. Please note that FIG. 18 shows relative etching rates in various portions as values in a range of from 0 to 1, assuming that the etching rate of the portion at which etching progresses faster than any other portions is 1. FIG. 18 does not show the absolute value of the etching progress rate.

The line width and the space width (groove width) at the bottom of the resist layer 26, the first mask layer 22, and the continuous recording layer 20 (divided recording elements 31) are shown in Table 1. The line width and the space width at the bottom of the resist layer 26 were measured after the resist layer processing step (S102) and before the second mask layer processing step (S104). The line width and the space width at the bottom of the first mask layer 22 were measured after the step (S106) serving as both the resist layer removal step and the first mask layer processing step and before the continuous recording layer processing step (S108). The line width and the space width at the bottom of the continuous recording layer 20 (divided recording elements 31) were measured after the continuous recording layer processing step (S108) and before the first mask layer removal step (S110).

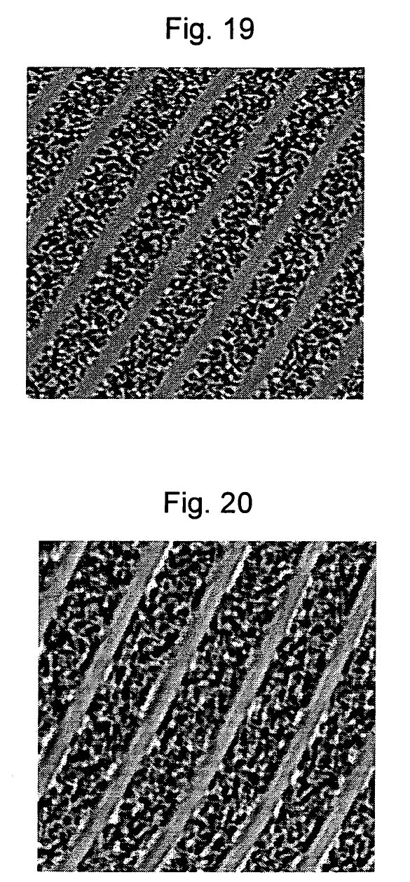

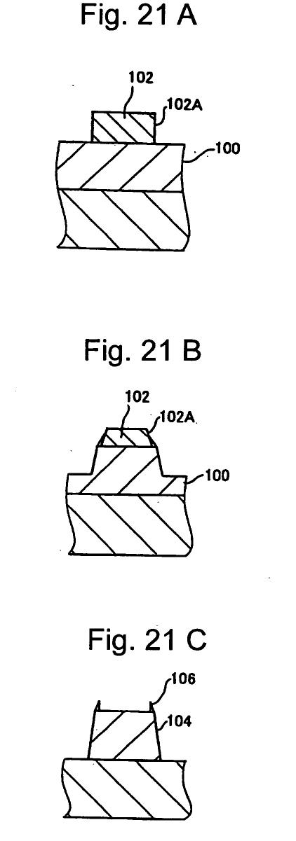

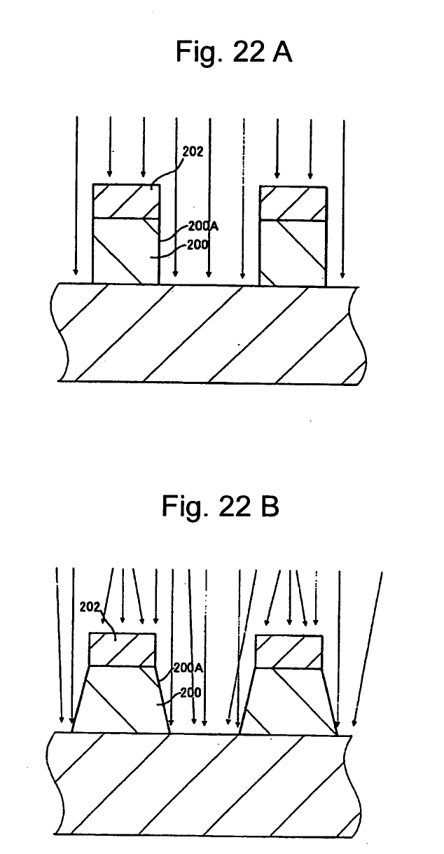

FIG. 19 shows an MFM image of that magnetic recording disc. It was confirmed that regions like minute spots of different shading were uniformly dispersed and the magnetic characteristics were good.

TABLE 1

| | |
|---|---|
| Example | Comparative Example 1 |

| | Line | Space | Line | Space |
|---|---|---|---|---|
| | width | width | width | width |
| Bottom of resist | 75 | 75 | 75 | 75 |
| layer | | | | |
| Bottom of the | 78 | 72 | 92 | 58 |
| first mask layer | | | | |
| Bottom of divided | 80 | 70 | 101 | 49 |
| recording element | | | | |

### COMPARATIVE EXAMPLE

Unlike Example described above, the continuous recording layer was processed by reactive ion etching using CO gas or the like as a reactive gas. The first mask layer was made of Ta (tantalum) to have a thickness of 25 nm, and was processed by reactive ion etching using SF₆ gas as a reactive gas. The first mask layer 22 remaining on the divided recording elements 31 was also removed by ashing using SF₆ gas as a reactive gas. The second mask layer was formed of Ni to have a thickness of 10 nm, and was processed by ion beam etching. In the above reactive ion etching, the object to be processed 10 was cooled by means of a cooling apparatus, and the objects to be processed 10 were processed one by one. Except for the above, the conditions were the same as those in Example.

For each of the processes of the second mask layer, the first mask layer, and the continuous recording layer, the process temperature of the object to be processed and the time required for the process are shown below.

The second mask layer: approximately 90° C., approximately 30 seconds (Ar ion beams)

The first mask layer 22: 120° C. or less, approximately 20 seconds (Reactive gas: SF₆ gas)

The continuous recording layer: 250° C. to 300° C., approximately 60 seconds (Reactive gas: CO gas or the like)

The manufactured magnetic recording disc had a diameter of approximately 2.5 inches. Warpage of that magnetic recording disc was approximately 10 μm.

The relationship between the distance from the end of that magnetic recording disc and the etching rate of the continuous recording layer is shown with Curve B in FIG. 18. It was confirmed that the etching rate of the continuous recording layer tended to increase as the distance from the end became smaller. In other words, at the end of the object to be processed, the etching rate was larger than that in the other portions and variation in the processed dimensions became largely. Therefore, a region near the end cannot be used as a magnetic recording region in some cases. This reduces the recording capacity.

The line width and the space width (groove width) at the bottom of the resist layer 26, the first mask layer 22, and the continuous recording layer 20 (divided recording elements 31) are shown in Table 1.

In addition, an MFM image of that magnetic recording disc is shown in FIG. 20. It was confirmed that, although the minute regions of different shading were dispersed, a part of them was arranged in a line extending along the periphery of the divided recording element and the magnetic degradation occurred.

In other words, it was confirmed that the magnetic recording disc of Example was better in the magnetic characteristics than the magnetic recording disc of Comparative Example. This is because the time required for processing the respective mask layers and the continuous recording layer in Example was shorter than that in Comparative Example and the process temperature in Example was lower than that in Comparative Example. It should be noted that, in Comparative Example, the process temperature was suppressed in the continuous recording layer processing step by using a cooling apparatus, as described above. That is, if the continuous recording layer were processed by reactive ion etching using no cooling apparatus as in Example, the process temperature would further increase and the magnetic degradation of the magnetic recording disc of Comparative Example would become larger.

Moreover, in the magnetic recording disc of Example, the shape of the divided recording elements was more stable than that in the magnetic recording disc of Comparative Example. Also, variation in the shape between the portions in the magnetic recording disc of Example was smaller than that in Comparative Example. This is because variation of the etching rate of the continuous recording layer between portions was less in Example than in Comparative Example.

Furthermore, as shown in Table 1, although the space width at the bottom of the resist layer 26 in Example was the same as that in Comparative Example, the space width at the bottom of the continuous recording layer 20 (divided recording element 31) in Example was larger than that in Comparative Example. In other words, the transfer precision was better in Example than in Comparative Example. The reason for this is considered as follows. In Example, the first mask layer 22 was formed of DLC and the second mask layer 24 was formed of Si. Thus, the thickness of the first mask layer 22 and that of the second mask layer 24 could be made thinner, as compared with those in Comparative Example. This contributed to suppression of the tapered angle of the side face of the portion to be processed.

### INDUSTRIAL APPLICABILITY

The present invention can be applied to the manufacturing of a magnetic recording medium in which divided recording layers are formed on both surfaces of a substrate.

1. A manufacturing method of a magnetic recording medium, for processing an object to be processed in which continuous recording layers are formed on both surfaces of a substrate to form divided recording layers each formed by a number of divided recording elements on both the surfaces of the substrate, comprising:
a processing step of simultaneously processing both the surfaces of the object to be processed.

2. The manufacturing method of a magnetic recording medium according to claim 1, wherein:
the object to be processed includes the continuous recording layer, a mask layer, and a resist layer formed on each of the surfaces of the substrate in that order; and
the manufacturing method comprises
a resist layer processing step of processing the resist layer in a predetermined pattern,
a mask layer processing step of processing the mask layer in the pattern based on the resist layer, and
a continuous recording layer processing step of processing the continuous recording layer in the pattern based on the mask layer to divide the continuous recording layer into the number of divided recording elements; and
at least one of the resist layer processing step, the mask layer processing step, and the continuous recording layer processing step is performed to simultaneously process both the surfaces of the object to be processed.

3. The manufacturing method of a magnetic recording medium according to claim 2, wherein
the resist layer processing step simultaneously transfers the pattern onto the resist layers on both the surfaces of the object to be processed by imprinting.

4. The manufacturing method of a magnetic recording medium according to claim 2, wherein
the continuous recording layer processing step simultaneously processes the continuous recording layers on both the surfaces of the object to be processed by ion beam etching.

5. The manufacturing method of a magnetic recording medium according to claim 2, further comprising a resist layer removal step of removing the resist layer before the continuous recording layer processing step.

6. The manufacturing method of a magnetic recording medium according to claim 2, further comprising a deposition step of depositing the continuous recording layer, the mask layer, and the resist layer, wherein the deposition step simultaneously deposits at least one of the continuous recording layer, the mask layer, and the resist layer on both sides of the substrate.

7. The manufacturing method of a magnetic recording medium according to claim 1, wherein
a plurality of the objects to be processed are processed simultaneously.

8. The manufacturing method of a magnetic recording medium according to claim 1, wherein
all the steps are preformed to simultaneously process both the surfaces of the object to be processed.

9. A manufacturing apparatus of a magnetic recording medium, for processing an object to be processed in which continuous recording layers are formed on both surfaces of a substrate to form divided recording layers each formed by a number of divided recording elements on both the surfaces of the substrate, comprising a processing device for simultaneously processing both the surfaces of the substrate.

10. The manufacturing apparatus of a magnetic recording medium according to claim 9, comprising:
a resist layer processing device for processing a resist layer of the object to be processed in a predetermined pattern, in the object the continuous recording layer, a mask layer, and the resist layer being formed on each of the surfaces of the substrate in that order;
a mask layer processing device for processing the mask layer in the pattern based on the resist layer; and
a continuous recording layer processing device for processing the continuous recording layer in the pattern based on the mask layer to divide the continuous recording layer into the number of divided recording elements, wherein
at least one of the resist layer processing device, the mask layer processing device, and the continuous recording layer processing device is configured to simultaneously process both the surfaces of the object to be processed.

11. The manufacturing apparatus of a magnetic recording medium according to claim 10, wherein
the resist layer processing device is a press device which is configured to simultaneously transfer the pattern onto the resist layers on both the surfaces of the object to be processed by imprinting.

12. The manufacturing apparatus of a magnetic recording medium according to claim 10, wherein
the continuous recording layer processing device is an ion beam etching device which is configured to simultaneously process the continuous recording layers on both the surfaces of the object to be processed by ion beam etching.

13. The manufacturing apparatus of a magnetic recording medium according to claim 10, further comprising a deposition device for simultaneously depositing at least one of the continuous recording layers, the mask layers, and the resist layers on both sides of the substrate symmetrically.

14. The manufacturing apparatus of a magnetic recording medium according to claim 9, further comprising a holder for holding a plurality of the objects to be processed to enable simultaneous process of the plurality of objects to be processed.

15. The manufacturing apparatus of a magnetic recording medium according to claim 9, wherein
both the surfaces of the object to be processed are simultaneously processed in all processing devices.

16. The manufacturing method of a magnetic recording medium according to claim 3, wherein
the continuous recording layer processing step simultaneously processes the continuous recording layers on both the surfaces of the object to be processed by ion beam etching.

17. The manufacturing method of a magnetic recording medium according to claim 3, further comprising a resist layer removal step of removing the resist layer before the continuous recording layer processing step.

18. The manufacturing method of a magnetic recording medium according to claim 3, further comprising a deposition step of depositing the continuous recording layer, the mask layer, and the resist layer, wherein the deposition step simultaneously deposits at least one of the continuous recording layer, the mask layer, and the resist layer on both sides of the substrate.

19. The manufacturing method of a magnetic recording medium according to claim 2, wherein
a plurality of the objects to be processed are processed simultaneously,

20. The manufacturing method of a magnetic recording medium according to claim 2, wherein
all the steps are performed to simultaneously process both the surfaces of the object to be processed.
